(19) United States
(12) Patent Application Publication
(10) Pub. No.: US 2026/0245462 A1
(43) Pub. Date: Aug. 20, 2026

(54) INFORMATION PROCESSING DEVICE, INFORMATION PROCESSING METHOD, AND INFORMATION PROCESSING SYSTEM

(71) Applicant: SONY SEMICONDUCTOR SOLUTIONS CORPORATION, KANAGAWA (JP)

(72) Inventor: KAZUMA SHIGEMATSU, KANAGAWA (JP)

(21) Appl. No.: 19/164,590

(22) PCT Filed: Mar. 4, 2024
(86) PCT No.: PCT/JP2024/007939

§ 371 Date: Sep. 12, 2025

(30) Foreign Application Priority Data
Mar. 27, 2023 (JP) 2023-049215

(51) Int. Cl. G08G 1/16; B60W 30/06; G06T 13/20; G06T 15/00; G06V 10/77; G06V 20/58; G08G 1/14

(52) U.S. Cl. CPC G08G 1/168; B60W 30/06; G06T 13/20; G06T 15/00; G06V 10/7715; G06V 20/58; G08G 1/142

(57) ABSTRACT

The present technology relates to an information processing device, an information processing method, and an information processing system that make it possible to reduce anxiety for drivers. The information processing device includes an image generation section that generates a virtual space image on the basis of three-dimensional shape data of an adjacent vehicle that is adjacent to a parking position where parking of an own vehicle is planned, the virtual space image indicating a result of simulation of the parking of the own vehicle in the parking position, the simulation being performed on the basis of the three-dimensional shape data and sensing data obtained through sensing of surroundings of the own vehicle. The present technology is applicable to vehicles.

### TECHNICAL FIELD

The present technology relates to an information processing device, an information processing method, and an information processing system, and more particularly, to an information processing device, an information processing method, and an information processing system that make it possible to reduce anxiety for drivers.

### BACKGROUND ART

Many vehicles that are available in today's market are mounted with automatic parking assistance functions. Most of the automatic parking assistance functions mainly use both surround cameras and sonar sensors to detect parking spaces and obstacles and propose parking position to a driver.

As technologies related to the above-described automatic parking assistance, a technology of calculating a parking position been proposed (for example, see Patent Literature 1). According to this technology, the parking position is calculated on the basis of a result of detecting a space where parking of an own vehicle is available, a result of recognizing statuses of occupants and luggage in the own vehicle, and a result of recognizing an environment around the own vehicle and statuses of other vehicles, for example.

In addition, for example a method and system of determining whether it is possible for a vehicle to pass through a gap have been proposed (for example, see Patent Literature 2).

### CITATION LIST

### Patent Literature

Patent Literature 1: JP2009-202610A
Patent Literature 2: JP 2008-108240A

### DISCLOSURE OF INVENTION

### Technical Problem

However, according to the above-described technologies, sometimes it is impossible to accurately detect a so-called free space that is an area where there is no object or obstacle in a place with poor visibility or the like. In this case, drivers feel anxiety about parking.

For example, according to the technology described in Patent Literature 1 and the like, detection of parking available areas depends only on sensing data of the own vehicle, and it is impossible to detect or estimate the free space (area where there is no object or obstacle) outside angles of view of the surround cameras and sonar sensors.

In a similar way, the technology described in Patent Literature 2 also relates to a system that depends only on image data directly acquired by the own vehicle, and it is also impossible to detect or estimate areas outside angles of view of its sensors.

The present technology is made in view of the above described situation, and it is intended to reduce anxiety for drivers.

### Solution to Problem

An information processing device according to an aspect of the present technology includes an image generation section that generates a virtual space image on the basis of three-dimensional shape data of an adjacent vehicle that is adjacent to a parking position where parking of an own vehicle is planned, the virtual space image indicating a result of simulation of the parking of the own vehicle in the parking position, the simulation being performed on the basis of the three-dimensional shape data and sensing data obtained through sensing of surroundings of the own vehicle.

An information processing method according to an aspect of the present technology includes generating a virtual space image on the basis of three-dimensional shape data of an adjacent vehicle that is adjacent to a parking position where parking of an own vehicle is planned, the virtual space image indicating a result of simulation of the parking of the own vehicle in the parking position, the simulation being performed on the basis of the three-dimensional shape data and sensing data obtained through sensing of surroundings of the own vehicle.

An information processing system according to an aspect of the present technology is an information processing system including the information processing device according to the aspect of the present technology.

According to an aspect of the present technology, a virtual space image is generated on the basis of three-dimensional shape data of an adjacent vehicle that is adjacent to a parking position where parking of an own vehicle is planned, the virtual space image indicating a result of simulation of the parking of the own vehicle in the parking position, the simulation being performed on the basis of the three-dimensional shape data and sensing data obtained through sensing of surroundings of the own vehicle.

### BRIEF DESCRIPTION OF DRAWINGS

FIG. 1 is a diagram illustrating a configuration example of an information processing system.

FIG. 2 is a flowchart for describing an automatic parking assistance process.

FIG. 3 is a flowchart for describing a highly accurate automatic parking assistance process.

FIG. 4 is a diagram for describing extraction of feature amounts

FIG. 5 is a diagram illustrating a display screen example.

FIG. 6 is a diagram illustrating a display screen example.

FIG. 7 is a diagram illustrating a configuration example of a computer.

### MODE(S) FOR CARRYING OUT THE INVENTION

Hereinafter, an embodiment to which the present technology is applied will be described with reference to the drawings.

### First Embodiment

### Configuration Example of Information Processing System

When using the automatic parking assistance function according to the present technology, specific vehicle types of adjacent vehicles that are adjacent to an own vehicle are identified, and attitudes and relative positions of the adjacent vehicles are detected (estimated) by finding feature amounts from vehicle video obtained using surround cameras during parking. In addition, it is also possible to complement vehicle bodies of the adjacent vehicles outside viewing angles of surround cameras by using highly accurate three-dimensional shape data for each vehicle type, the three-dimensional shape data including three-dimensional shapes of the identified vehicle types.

This makes it possible to predict the free space on the parking route of the own vehicle more accurately, and it becomes possible to let the drivers to use the automatic parking assistance without feeling anxiety even in a narrow parking lot where it is difficult to assist automatic parking.

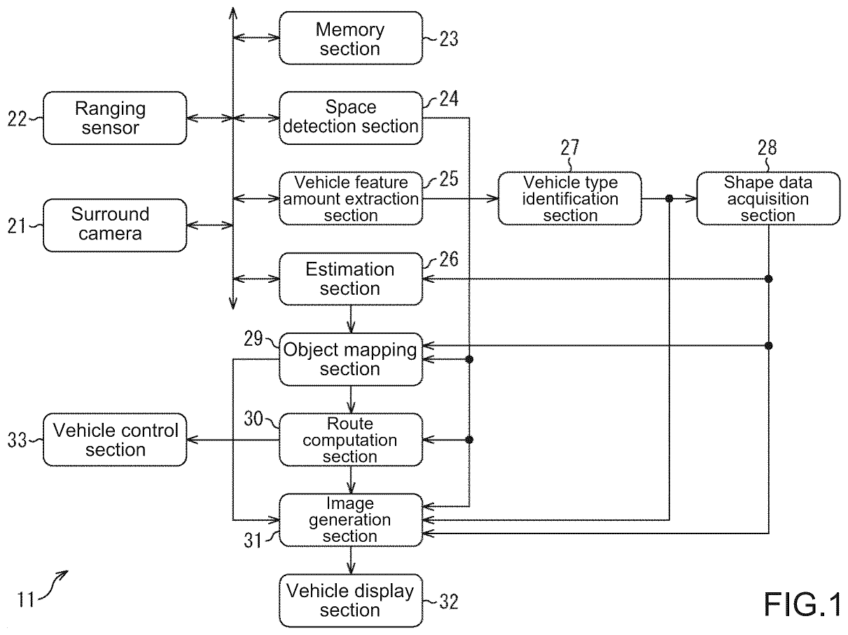

FIG. 1 is a diagram illustrating a configuration example of an embodiment of the information processing system to which the present technology is applied.

An information processing system 11 illustrated in FIG. 1 includes an information processing device provided in a vehicle and other components, and achieves the automatic parking assistance function of assisting parking of a vehicle.

Note that, hereinafter, a vehicle provided with the information processing system 11 is referred to as an own vehicle, and a vehicle adjacent to the own vehicle, more specifically, a vehicle parked adjacent to a position (space) where parking of the own vehicle is planned is referred to as an adjacent vehicle.

The information processing system 11 includes a surround camera 21, a ranging sensor 22, a memory section 23, a space detection section 24, a vehicle feature amount extraction section 25, an estimation section 26, a vehicle type identification section 27, a shape data acquisition section 28, an object mapping section 29, a route computation section 30, an image generation section 31, a vehicle display section 32, and a vehicle control section 33.

In addition, for example, the surround camera 21 to the estimation section 26 are connected to each other via a bus or the like.

The surround camera 21 acquires image data of an omnidirectional image by capturing an image of surroundings of the own vehicle as a subject, and supplies it to the memory section 23.

For example, the omnidirectional image is video (moving image) including overall surroundings of the own vehicle as the subject. The omnidirectional image includes surrounding vehicles and the like as its subjects.

For example, the ranging sensor 22 includes a sonar sensor, a radar, Lidar (light detection and ranging), or the like. The ranging sensor 22 measures a distance from the own vehicle to an object such as the adjacent vehicle, obstacle, and the like around the own vehicle and supplies resulting ranging data to the memory section 23.

Hereinafter, data obtained through image capturing, ranging, and the like that means sensing of surroundings of the own vehicle, in other words, data such as the image data of the omnidirectional image and the ranging data is referred to as sensing data.

The memory section 23 temporarily records therein the sensing data such as the image data supplied from the surround camera 21 or the ranging data supplied from the ranging sensor 22, and supplies the recorded sensing data to a block such as the space detection section 24 appropriately.

On the basis of the sensing data recoded (stored) on the memory section 23, the space detection section 24 detects the free space or the like that is a space where parking of an own vehicle is available, and supplies a result of the detection to the object mapping section 29, the route computation section 30, and the image generation section 31.

The vehicle feature amount extraction section 25 extracts feature amounts (hereinafter, also referred to as vehicle feature amounts) of the adjacent vehicle from the omnidirectional image on the basis of the image data of the omnidirectional image serving as the sensing data recorded on the memory section 23. For example, the extraction of the vehicle feature amounts allows the vehicle feature amount extraction section 25 to extract specific parts of the adjacent vehicle such as an emblem or front grille. The vehicle feature amount extraction section 25 supplies the extracted vehicle feature amounts to the estimation section 26 and the vehicle type identification section 27.

The estimation section 26 estimates an attitude and relative position of the adjacent vehicle on the basis of the sensing data recorded on the memory section 23, the vehicle feature amounts obtained by the vehicle feature amount extraction section 25, and the three-dimensional shape data of the adjacent vehicle supplied from the shape data acquisition section 28, and then supplies a result of the estimation to the object mapping section 29.

The vehicle type identification section 27 identifies the vehicle type of the adjacent vehicle on the basis of the vehicle feature amounts supplied from the vehicle feature amount extraction section 25, and supplies vehicle type information indicating a result of the identification to the shape data acquisition section 28 and the image generation section 31. The vehicle feature amounts are extracted from the image data of the omnidirectional image. Therefore, it may be said that the vehicle type identification section 27 identifies the vehicle type of the adjacent vehicle on the basis of the image data of the omnidirectional image.

For example, the vehicle type identification section 27 stores therein prestored vehicle feature amounts for respective vehicle types as a feature amount database, and identifies the vehicle type by checking the vehicle feature amounts obtained from the vehicle feature amount extraction section 25 against the vehicle feature amounts registered in the feature amount database.

Note that it is also possible to identify vehicle types by using cloud services or the like including an external server or the like.

In this case, for example, the external server stores therein the feature amount database, and the vehicle type identification section 27 transmits the vehicle feature amount from the vehicle feature amount extraction section 25 to the server and requests identification of the vehicle type. Then, the server identifies the vehicle type on the basis of the vehicle feature amounts received from the vehicle type identification section 27 (information processing system 11) and the stored feature amount database, and transmits the vehicle type information indicating a result of the identification to the information processing system 11.

The vehicle type identification section 27 identifies the vehicle type of the adjacent vehicle by receiving (acquiring) the vehicle type information transmitted from the server in this way.

The shape data acquisition section 28 acquires the three-dimensional shape data indicating a highly accurate three-dimensional shape of the vehicle (adjacent vehicle) of the vehicle type indicated by the vehicle type information on the basis of the vehicle type information supplied from the vehicle type identification section 27, and then supplies it to the estimation section 26, the object mapping section 29, and the image generation section 31. For example, the three-dimensional shape data may include vehicle texture information or the like.

The shape data acquisition section 28 stores (records) therein the three-dimensional shape database including the three-dimensional shape data for respective vehicle types in advance. In other words, the shape data acquisition section 28 stores therein the three-dimensional shape data for the respective vehicle types in a built-in memory with regard to the plurality of vehicle types.

For example, the shape data acquisition section 28 reads out the three-dimensional shape data of the vehicle type indicated by the vehicle type information from the three-dimensional shape database and acquires the three-dimensional shape data of the vehicle type of the adjacent vehicle.

Alternatively, for example, in a case where the three-dimensional shape database does not include the three-dimensional shape data of the vehicle type indicated by the vehicle type information, it is also possible to acquire the three-dimensional shape data by using the cloud services or the like including the external server or the like.

In this case, for example, the external server stores therein the three-dimensional shape database, and the shape data acquisition section 28 transmits the vehicle type information from the vehicle type identification section 27 to the server and requests transmission of the three-dimensional data.

Then, from the stored three-dimensional shape database, the server reads out the three-dimensional shape data of the vehicle type indicated by the vehicle type information received from the shape data acquisition section 28 (information processing system 11) and transmits it to the information processing system 11. The shape data acquisition section 28 receives (acquires) the three-dimensional shape data transmitted from the server in this way.

Note that, in the case of using the external server or the like, the server that records therein the feature amount database or the like and the server that records therein the three-dimensional shape database or the like may be a same server or the like or may be different servers or the like.

The object mapping section 29 performs object mapping on the basis of the results of estimating the attitude and the relative position of the adjacent vehicle supplied from the estimation section 26, the result of detecting the free space or the like supplied from the space detection section 24, and the three-dimensional shape data from the shape data acquisition section 28.

According to the object mapping, it is possible to dispose (map) a three-dimensional own vehicle object representing the own vehicle and a three-dimensional adjacent vehicle object representing the adjacent vehicle, in a three-dimensional virtual space that imitates a space around the own vehicle and the adjacent vehicle, the space including the parking space of the own vehicle, for example. This makes it possible to accurately replicate the three-dimensional ambient space including the parking space of the own vehicle as the three-dimensional virtual space.

The object mapping section 29 supplies a result of the object mapping (hereinafter, also referred to as a mapping result) to the route computation section 30 and the image generation section 31.

The route computation section 30 computes a parking route for parking the own vehicle in the parking position on the basis of a portion or all of the result of detecting the free space or the like supplied from the space detection section 24, the mapping result supplied from the object mapping section 29, or the like.

The route computation section 30 supplies the image generation section 31 and the vehicle control section 33 with the parking route of the own vehicle obtained through the computation, that is, route information indicating a route (parking track) for parking from a current own vehicle position to the parking position.

The image generation section 31 generates image data of various kinds of screens (images) to be presented to the driver by appropriately using the information supplied from the space detection section 24, the vehicle type information from the vehicle type identification section 27, the three-dimensional shape data from the shape data acquisition section 28, the mapping result from the object mapping section 29, or the route information from the route computation section 30. The image generation section 31 supplies the generated image data to the vehicle display section 32.

The vehicle display section 32 is implemented by a display device such as a compact display, and the vehicle display section 32 displays the various kinds of images supplied from the image generation section 31.

The vehicle control section 33 controls parking of the own vehicle, more specifically, or more specifically, behavior of parking of the own vehicle on the basis of the route information supplied from the route computation section 30. For example, the vehicle control section 33 controls driving or steering of the own vehicle in such a manner that the own vehicle travels (moves) along a route indicated by the route information.

The above-described information processing system 11 includes the information processing device including a portion or all among the surround camera 21 to the vehicle control section 33 as its components.

The vehicle display section 32 serving as the display device may be included in the information processing device, or may be provided as a component that is different from the information processing device of the information processing system 11.

### Description of Automatic Parking Assistance Process

Next, behavior of the information processing system 11 will be described.

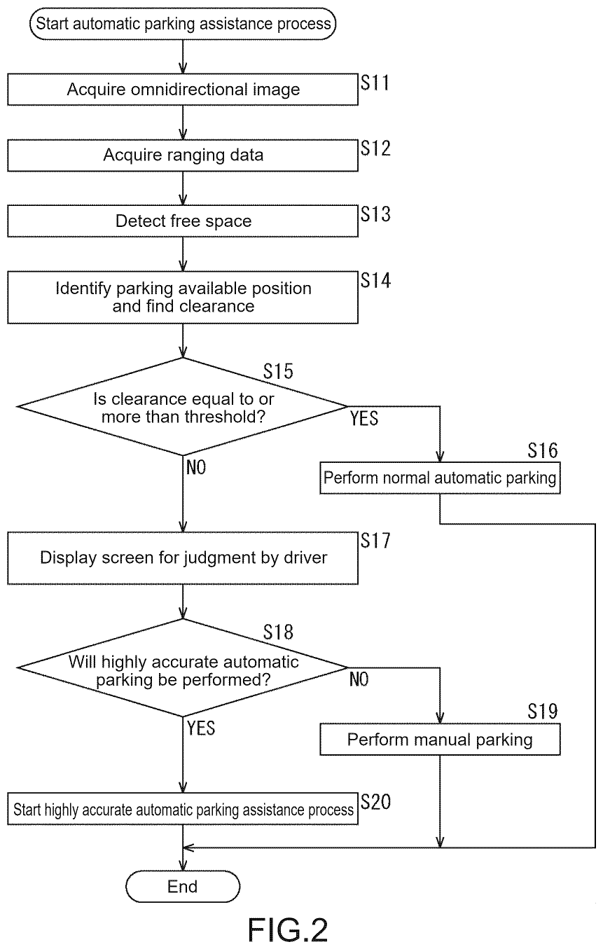

For example, the information processing system 11 executes an automatic parking assistance process illustrated in FIG. 2 when the driver who is an occupant (user) of the own vehicle operates an input section (not illustrated) to instruct the information processing system 11 to start the automatic parking assistance for the own vehicle.

Next, the automatic parking assistance process executed by the information processing system 11 will be described with reference to the flowchart illustrated in FIG. 2.

In Step S11, the surround camera 21 acquires image data of an omnidirectional image by capturing an image of surroundings of the own vehicle, supplies it to the memory section 23, and records it on the memory section 23.

In Step S12, the ranging sensor 22 acquires ranging data through ranging, supplies it to the memory section 23, and records it on the memory section 23.

In Step S13, the space detection section 24 detects a free space where parking of an own vehicle is available on the basis of sensing data recorded on the memory section 23, that is, the image data of the omnidirectional image and the ranging data.

For example, as the free space, the space detection section 24 detects a two-dimensional region where parking of the own vehicle is available from a ground region captured as a subject in the omnidirectional image.

In Step S14, the space detection section 24 identifies a position where parking of the own vehicle is available in the two-dimensional free space as a parking available position and finds left-right clearance on the basis of the sensing data from the memory section 24 and the result of detecting the free space.

Here, the clearance means a distance between the own vehicle and an edge of a space through which the own vehicle passes when parking in the parking available position, that is, a gap with the adjacent vehicle when parking. For example, the clearance can be obtained from the result of identifying (detecting) the free space or the parking available position, traveling speed of the own vehicle, the omnidirectional image, or the like.

Specifically, for example, as the left-right clearance of the vehicle, the space detection section 24 calculates a value obtained by dividing a difference between the vehicle width of the own vehicle and the width of the space through which the own vehicle passes when parking in the parking available position by 2. For example, in a case where adjacent vehicles are parked on a left side and a right side of the parking available position, a minimum value of a distance between the adjacent vehicles is considered as the width of the space through which the own vehicle passes.

Note that, hereinafter, the description will be continued on the assumption that there is the adjacent vehicle on at least one of the left and right sides of the parking available position.

In Step S15, the space detection section 24 determines whether the obtained clearance is equal to or more than a predetermined threshold that has been set in advance.

Note that, for example, sometimes the surround camera 21, the ranging sensor 22, or the like has a limited angle of view depending on a positional relation or the like between the own vehicle and the parking space. This may result in lack of enough sensing data to perform highly accurate automatic parking (to be described later) or failing to find the correct clearance. In this case, it is determined that the clearance is less than the threshold in Step S15. The highly accurate automatic parking is parking control using three-dimensional shape data of adjacent vehicles.

In a case where it is determined that the clearance is equal to or more than the threshold in Step S15, that is, there is a sufficiently safe gap (distance) enough to perform normal automatic parking at the parking available position for the own vehicle, the process proceeds to Step S16.

In Step S16, the vehicle control section 33 performs the normal automatic parking.

In the normal automatic parking, the vehicle control section 33 controls parking by using the results of identifying the parking available position and free space obtained by the space detection section 24, the clearance, the sensing data recorded on the memory section 23, and the like.

In particular, the normal automatic parking does not use the three-dimensional shape data of the adjacent vehicle. This is because the enough clearance is ensured and it is possible to achieve sufficiently safe parking without finding the clearance or the parking route accurately.

For example, in a case of performing the normal automatic parking, the space detection section 24 supplies the route computation section 30 with the result of identifying the free space obtained in Step S13, the result of identifying the parking available position obtained in Step S14, and the result of computing the clearance. In addition, the space detection section 24 reads out the sensing data from the memory section 23 and supplies it to the route computation section 30 as necessary.

The route computation section 30 uses the parking available position as the parking position of the own vehicle, computes the parking route from the current position to the parking position of the own vehicle on the basis of the results of identifying the free space and the parking available position, the clearance, the sensing data, and the like supplied from the space detection section 24, and supplies the vehicle control section 33 with the route information indicating a result of the computation.

The vehicle control section 33 controls the behavior of the own vehicle, that is, the driving or steering of the own vehicle in such a manner that the parking of the own vehicle is achieved through the parking route indicated by the route information on the basis of the route information supplied from the route computation section 30.

The automatic parking assistance process ends when the normal automatic parking is achieved.

On the other hand, in the case where it is determined that the clearance is less than the threshold in Step S15, the space detection section 24 appropriately supplies the image generation section 31 with the result of computing the clearance. Subsequently, the process proceeds to Step S17.

In Step S17, the image generation section 31 generates image data by appropriately using the result of computing the clearance supplied from the space detection section 24 or the like, supplies the generated image data to the vehicle display section 32, and causes a screen for judgment by the driver to be displayed.

In this case, for example, the screen that is displayed by the vehicle display section 32 on the basis of the image data appropriately displays the result of computing the clearance, information indicating whether the highly accurate automatic parking is available, or the like. For example, the screen may display a message that the highly accurate automatic parking is not available, in a case where the clearance is too small and is equal to or less than another threshold that is less than the threshold used in Step S15, in a case where the enough sensing data to perform highly accurate automatic parking is not obtained, or in other cases.

In addition, the screen based on the image data also displays buttons or the like that allow the driver to select whether to perform the highly accurate automatic parking. The driver operates these buttons to input a result of selecting whether to perform the highly accurate automatic parking or manual parking.

In Step S18, the information processing system 11 determines whether to perform the highly accurate automatic parking on the basis of a signal output from the input section (not illustrated) in response to the operation performed on the button by the driver or the like.

The information processing system 11 stops the automatic parking assistance and then process proceeds to Step S19 in a case where it is determined that the highly accurate automatic parking will not be performed in Step S18, that is, in a case where it is determined that the manual parking based on driving operation by the driver himself/herself will be performed.

In Step S19, the vehicle control section 33 performs the manual parking. For example, in Step S19, the vehicle control section 33 controls behavior of the own vehicle in response to operation performed on a steering wheel or the like by the driver. The automatic parking assistance process ends when the manual parking is achieved.

In addition, in a case where it is determined that the highly accurate automatic parking will be performed in Step S18, the information processing system 11 starts a highly accurate automatic parking assistance process in Step S20.

As will be described later, the highly accurate automatic parking assistance process uses the three-dimensional shape data of the adjacent vehicle to control parking. The automatic parking assistance process ends when the highly accurate automatic parking assistance process is achieved.

As described above, the information processing system 11 finds the free space and the clearance on the basis of the sensing data. In a case where the clearance is less than the threshold, the highly accurate automatic parking assistance process starts depending on a judgment by the driver. This makes it possible to achieve the appropriate parking assistance.

### Description of Highly Accurate Automatic Parking Assistance Process

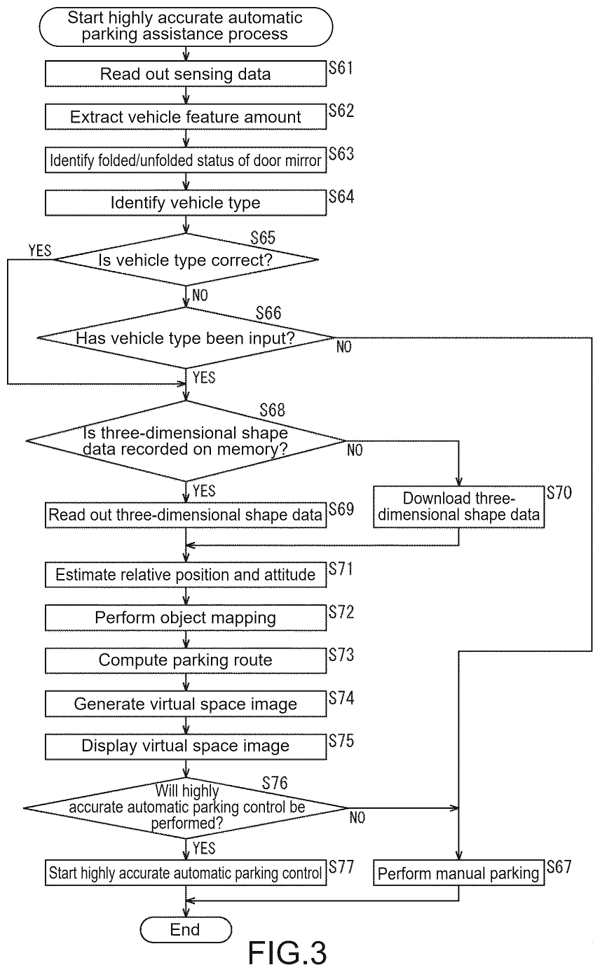

In Step S20 illustrated in FIG. 2, the information processing system 11 starts a highly accurate automatic parking assistance process illustrated in FIG. 3, for example. Next, the highly accurate automatic parking assistance process executed by the information processing system 11 will be described with reference to a flowchart illustrated in FIG. 3.

In Step S61, the vehicle feature amount extraction section 25 and the estimation section 26 read out the sensing data recorded on the memory section 23. The sensing data that is read out at this time is the image data obtained in Step S11 and the ranging data obtained in Step S12 in FIG. 2.

In Step S62, the vehicle feature amount extraction section 25 extracts the vehicle feature amounts of the adjacent vehicle from the omnidirectional image on the basis of the image data of the omnidirectional image serving as the sensing data that is read out from the memory section 23.

For example, the vehicle feature amount extraction section 25 stores therein a feature amount extractor including a deep neural network (DNN) that is obtained through learning in advance. The vehicle feature amount extraction section 25 obtains one vehicle feature amount or a plurality of vehicle feature amounts as output from the feature amount extractor by performing arithmetic while using the omnidirectional image as input into the feature amount extractor.

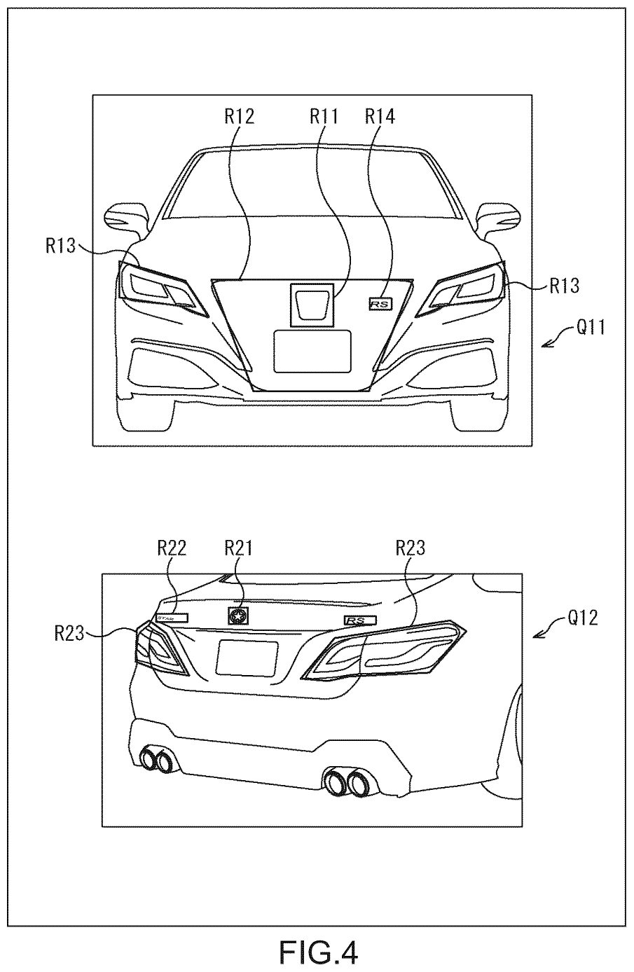

FIG. 4 illustrates a specific example of the extraction of vehicle feature amounts.

As indicated by an arrow Q11 in FIG. 4, it is assumed that the omnidirectional image includes a front portion of the adjacent vehicle as a subject.

In this example, as the vehicle feature amounts, an emblem in a region R11, a front grille in a region R12, headlamps in regions R13, a plate indicating a model/class of the vehicle in a region R14, and the like are extracted from the omnidirectional image, for example.

In addition, as indicated by an arrow Q12, sometimes the omnidirectional image includes a rear portion of the adjacent vehicle as a subject.

In this case, an emblem in a region R21, a plate indicating the vehicle type in a region R22, taillamps in regions R23, and the like are extracted as the vehicle feature amounts, for example.

The vehicle feature amount extraction section 25 extracts specific parts of the vehicle such as the emblem, that is, specific objects as the vehicle feature amounts. The vehicle feature amounts extracted in this way is data that is fundamental to the identification of the vehicle type of the adjacent vehicle.

Note that the extraction of the vehicle feature amount may be performed in any way, and any vehicle feature amount can be used as long as it is possible to identify the vehicle type.

Referring back to the flowchart illustrated in FIG. 3, the process proceeds to Step S63 after the vehicle feature amount is extracted.

In Step S63, the vehicle feature amount extraction section 25 identifies a folded/unfolded status of a door mirror of the adjacent vehicle included in the omnidirectional image as a subject on the basis of the image data of the omnidirectional image.

For example, the folded/unfolded status of the door mirror may be identified through image recognition or the like of the omnidirectional image, or may be identified by an identifier such as a DNN that receives the omnidirectional image as input and outputs a result of identifying the folded/unfolded status. Alternatively, the folded/unfolded status may be identified by the DNN or the like that is the same as the DNN used for the extraction of the vehicle feature amounts at a same time as the extraction of the vehicle feature amounts.

The vehicle feature amount extraction section 25 supplies the vehicle feature amounts extracted from the omnidirectional image and a result of identifying the folded/unfolded status of the door mirror to the estimation section 26 and the vehicle type identification section 27.

In Step S64, the vehicle type identification section 27 identifies the vehicle type of the adjacent vehicle on the basis of the vehicle feature amounts supplied from the vehicle feature amount extraction section 25, and supplies the shape data acquisition section 28 with the vehicle type information indicating a result of the identification and the result of identifying the folded/unfolded status of the door mirror. In addition, the vehicle type identification section 27 supplies the vehicle type information to the image generation section 31.

Specifically, for example, the vehicle type identification section 27 identifies the vehicle type by checking the supplied vehicle feature amounts against the prestored feature amount database.

At this time, for example, a vehicle manufacturer is identified from the emblem extracted as the vehicle feature amount. In addition, for example, the model of the adjacent vehicle is found by estimation (prediction) through pattern matching against the feature amount database on the basis of the shapes, positional relations, or the like of the specific parts such as the front grille and the headlamps extracted as the vehicle feature amounts, and reliability of the estimation of the vehicle type is also found.

This makes it possible to obtain the vehicle manufacturer and the model as a result of identifying the vehicle type, for example. In this case, for example, the vehicle type information includes information indicating the identified vehicle manufacturer and model, and the reliability of the result of the identifying (predicting) the vehicle type.

Note that, as described above, it is also possible for the vehicle type identification section 27 to identify the vehicle type by using an external cloud service or the like.

In this case, for example, the vehicle type identification section 27 does not check against the feature amount database but acquires the vehicle type information from the external server or the like. Alternatively, it is also possible to use the external cloud service when the vehicle type identification section 27 has checked against the feature amount database but has not obtained reliability that is equal to or more than a predetermined value.

In addition, as the result of identifying the vehicle type, the vehicle type information may include not only the information related to one vehicle type but also information related to a plurality of vehicle types. For example, it is conceivable that the vehicle type information includes the information related to the plurality of vehicle types in a case where reliabilities of respective vehicle types are equal to or less than the predetermined value and there is a plurality of candidates for the vehicle type of the adjacent vehicle. This makes it possible to present the plurality of vehicle types (results of identification) to the driver as the candidates for the vehicle type of the adjacent vehicle.

In addition, when the image generation section 31 receives the vehicle type information supplied from the vehicle type identification section 27, the image generation section 31 generates image data of a vehicle type notification screen on the basis of the vehicle type information. The vehicle type notification screen is a screen to notify the driver of the identified vehicle type, that is, a result of identifying the vehicle type. Next, the image generation section 31 supplies the generated image data to the vehicle display section 32 and causes the vehicle type notification screen to be displayed.

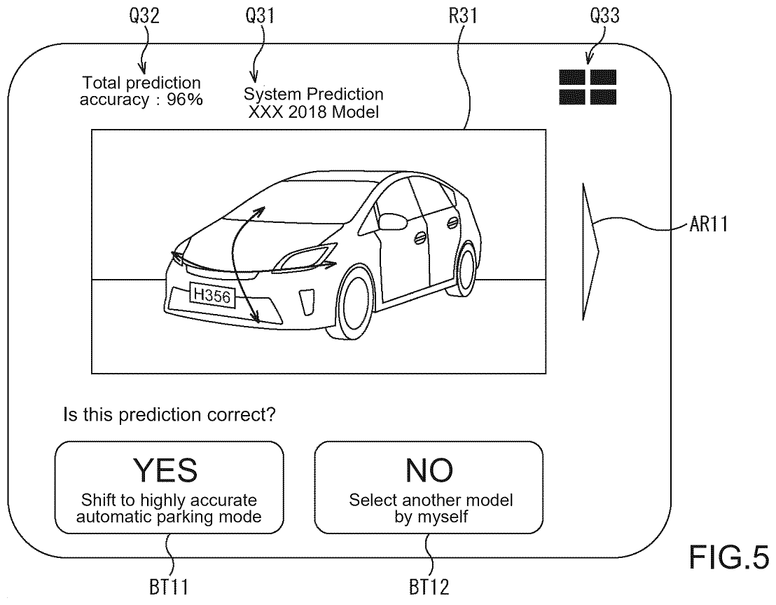

This allows the vehicle display section 32 to display the vehicle type notification screen illustrated in FIG. 5, for example.

In the example illustrated in FIG. 5, an image of the identified vehicle type (hereinafter, also referred to as a vehicle type image) is displayed in a display region R31.

For example, the image generation section 31 stores therein three-dimensional image data of the respective vehicle types and causes the vehicle image to be displayed on the basis of the three-dimensional image data. This allows the driver to enlarge/reduce the vehicle image or rotate the vehicle image to the left, right, top, or bottom by operating the input section such as a touchscreen provided in such a manner that the input section overlaps with the vehicle display section 32.

In addition, the vehicle type notification screen includes a portion indicated by an arrow Q31 and a portion indicated by an arrow Q32. The portion indicated by an arrow Q31 displays a vehicle manufacturer name, a vehicle model, or the like as a result of identifying the vehicle type indicated by the vehicle type information. The portion indicated by an arrow Q32 displays reliability of prediction of the vehicle type included in the vehicle type information, that is, reliability of the result of identifying the vehicle type.

In addition, it is also possible for the driver to switch views of the vehicle type notification screen by operating a portion indicated by an arrow Q33. Specifically, for example, when operating the portion indicated by the arrow Q33, the vehicle type notification screen displays a list of a plurality of candidates for the vehicle type of the adjacent vehicle.

In addition, in a case where there is the plurality of candidates for the vehicle type of the adjacent vehicle, a selection arrow AR11 is displayed in a predetermined color such as black. This allows the driver to easily recognize that there is the plurality of candidates for the vehicle type of the adjacent vehicle. In this case, it is possible for the driver to cause the display region R31 to display a vehicle image of another candidate by operating the selection arrow AR11.

The driver compares the actual adjacent vehicle with the vehicle image displayed in the display region R31 through his/her eyes while appropriately operating the selection arrow AR11 or the like, judges the vehicle type of the adjacent vehicle, and operates a button BT11 or a button BT12 depending on a result of the judgment.

For example, the driver operates the button BT11 in a case where the driver judges that the vehicle type presented on the vehicle type notification screen, i.e., the result of identification of the vehicle type performed by the information processing system 11 (vehicle type identification section 27) is correct. In other words, the driver operates the button BT11 to confirm the result of identification of the vehicle type performed by the information processing system 11.

On the button BT11, a text “YES” and a text “Shift to highly accurate automatic parking mode” are displayed. When the button BT11 is operated, a process necessary to start the highly accurate parking control will be performed subsequently.

On the other hand, the driver operates the button BT12 in a case where the driver judges that the vehicle type presented on the vehicle type notification screen, i.e., the result of identification of the vehicle type performed by the information processing system 11 (vehicle type identification section 27) is incorrect or wrong.

On the button BT11, a text “NO” and a text “Select another model by myself” are displayed. When the button BT12 is operated, the vehicle display section 32 displays a vehicle type input screen that allows the driver to select or input the vehicle type of the adjacent vehicle by himself/herself subsequently.

When the driver operates the input section (not illustrated) and operates the button BT11 or the button BT12, the input section supplies the image generation section 31 with a signal corresponding to the operation performed by the driver.

Referring back to the flowchart illustrated in FIG. 3, the image generation section 31 determines whether the vehicle type identified in Step S64 is correct in Step S65.

For example, in the example illustrated in FIG. 5, it is determined that the vehicle type is correct in a case where the button BT11 is operated, and it is determined that the vehicle type is incorrect in a case where the button BT12 or the like is operated.

In the case where it is determined that the vehicle type is correct in Step S65, the process proceeds to Step S68 to perform the highly accurate automatic parking subsequently.

On the other hand, in the case where it is determined that the vehicle type is incorrect in Step S65, the process proceeds to Step S66 subsequently.

In this case, for example, the driver operates the button BT12 illustrated in FIG. 5, and then selects the vehicle type of the adjacent vehicle from a vehicle type list or the like or inputs the vehicle type manually on the vehicle type input screen or the like. Alternatively, the driver performs an operation to stop the automatic parking assistance if the vehicle type is unknown or if the driver decides not to input the vehicle type for some reason like feeling lazy to perform the input operation.

In Step S66, the image generation section 31 determines whether the driver has input the vehicle type.

In the case where it is determined that the vehicle type has been input in Step S66, the process proceeds to Step S68 subsequently. In this case, the vehicle type identification section 27 identifies the vehicle type of the adjacent vehicle on the basis of a signal supplied from the input section (not illustrated) in response to the input operation performed by the driver, and supplies vehicle type information indicating a result of the identification to the shape data acquisition section 28.

On the other hand, in the case where it is determined that the vehicle type has not been input in Step S66, the information processing system 11 stops the automatic parking assistance, and the process proceeds to Step S67 subsequently.

In Step S67, the vehicle control section 33 performs the manual parking in response to operation performed on the steering wheel or the like by the driver. Subsequently, the highly accurate automatic parking assistance process ends. For example a process similar to the Step S19 in FIG. 2 is performed in Step S67.

In the case where it is determined that the vehicle type is correct in Step S65 or it is determined that the vehicle type has been input in Step S66, a process in Step S68 will be performed subsequently.

In Step S68, the shape data acquisition section 28 determines whether the three-dimensional shape data of the vehicle type indicated by the vehicle type information is recorded on its built-in memory, i.e., the three-dimensional database on the basis of the vehicle type information supplied from the vehicle type identification section 27.

For example, if the three-dimensional shape database only stores therein three-dimensional shape data of vehicle types that are seen frequently, this makes it possible to reduce memory capacity and to suppress frequency of downloading the three-dimensional data from an external device to a low frequency.

In a case where it is determined that the three-dimensional shape data is recorded on the memory in Step S68, the shape data acquisition section 28 reads out the three-dimensional shape data of the vehicle type indicated by the vehicle type information from the memory in Step S69.

At this time, for example, the shape data acquisition section 28 reads out, from the memory, the three-dimensional shape data of a status corresponding to a result of identifying the folded/unfolded status of the door mirror supplied from the vehicle type identification section 27 in Step S64. In other words, three-dimensional shape data of a three-dimensional shape indicating a status where a door mirror of the adjacent vehicle is unfolded or a status where a door mirror of the adjacent vehicle is folded is read out.

The shape data acquisition section 28 supplies the read-out three-dimensional shape data to the estimation section 26, the object mapping section 29, and the image generation section 31, and then the process proceeds to Step S71.

On the other hand, in a case where it is determined that the three-dimensional shape data is not recorded on the memory in Step S68, the shape data acquisition section 28 downloads the three-dimensional shape data of the vehicle type indicated by the vehicle type information from the external Server in Step S70.

In other words, the shape data acquisition section 28 requests transmission of the three-dimensional data by transmitting the vehicle type information to the server, and receives the three-dimensional shape data transmitted from the server in response to the request. Even in this case, for example, the three-dimensional shape data corresponding to a result of identifying the folded/unfolded status of the door mirror of the adjacent vehicle is downloaded in a way similar to the case in Step S69.

When the shape data acquisition section 28 downloads the three-dimensional shape data, the shape data acquisition section 28 supplies the three-dimensional shape data to the estimation section 26, the object mapping section 29, and the image generation section 31, and then the process proceeds to Step S71.

When the process in Step S69 or Step S70 is performed and the three-dimensional shape data of the vehicle type of the adjacent vehicle is obtained, the estimation section 26 estimates a relative position of the adjacent vehicle to the own vehicle and an attitude of the adjacent vehicle in Step S71.

For example, to estimate the relative position and the attitude, the ranging data and the image data of the omnidirectional image serving as the sensing data read-out from the memory section 23 in Step S61, the vehicle feature amount obtained in Step S62, and the result of identifying the folded/unfolded status of the door mirror obtained in Step S63 are used. In addition, the three-dimensional shape data of the adjacent vehicle obtained in Step S69 or Step S70 is also used to estimate the relative position and the attitude.

For example, the estimation section 26 estimates the relative position and the attitude by using at least the image data of the omnidirectional image among the image data of the omnidirectional image, the ranging data, the vehicle feature amounts, the result of identifying the folded/unfolded status of the door mirror, and the three-dimensional shape data of the adjacent vehicle.

This makes it possible to obtain position/attitude information indicating the relative position of the adjacent vehicle viewed from the own vehicle and the attitude of the adjacent vehicle viewed from the own vehicle, for example.

Note that the estimation section 26 estimates the relative position and the attitude in parallel with (substantially simultaneously with) the identification of the vehicle type of the adjacent vehicle performed on the basis of the vehicle feature amounts, for example. The estimation section 26 supplies the object mapping section 29 with the position/attitude information obtained in this way.

In Step S72, the object mapping section 29 performs the object mapping.

For example, the object mapping section 29 appropriately acquires the result of identifying the free space obtained in Step S13, the result of identifying the parking available position obtained in Step S14, the result of computing the clearance, or the like from the free space detection section 24.

The object mapping section 29 performs the object mapping on the basis of the acquired results of identifying the free space and the parking available position, the result of computing the clearance, the position/attitude information supplied from the estimation section 26, and the three-dimensional shape data from the shape data acquisition section 28.

In addition, more specifically, three-dimensional shape data of the own vehicle is also used for the object mapping. The three-dimensional shape data of the own vehicle may be recorded on the shape data acquisition section 28 or may be prerecorded on (prestored in) the object mapping section 29.

According to the object mapping, the parking available position, the own vehicle object, and the adjacent vehicle object that have three-dimensional shapes based on the three-dimensional shape data are disposed in the three-dimensional virtual space in same attitudes and positional relation as the actual attitudes and positional relation of the parking available position, the own vehicle object, and the adjacent vehicle object (in a real space).

In addition, the adjacent vehicle object has the three-dimensional shape indicating a status where the door mirror is folded or unfolded in response to the result of identifying the folded/unfolded status of the door mirror of the adjacent vehicle. Note that it is also possible for the object mapping section 29 or the like to identify the folded/unfolded status of the door mirror of the own vehicle and to map the own vehicle object that reflects the result of the identifying the status where the door mirror is folded or unfolded.

The object mapping section 29 generates computer graphics (CG) data obtained by disposing the own vehicle object and the adjacent vehicle object on data indicating a result of the object mapping, i.e., the three-dimensional virtual space, and supplies the generated data to the route computation section 30 and the image generation section 31.

Note that the data indicating a result of the object mapping is not limited to the CG data and may be any data as long as the three-dimensional shapes, attitudes, positional relations of the own vehicle object and the adjacent vehicle object in the three-dimensional virtual space can be recognized from this data.

In Step S73, the route computation section 30 computes the parking route of the own vehicle by using the CG data (mapping result) supplied from the object mapping section 29 at least, and supplies the image generation section 31 with the route information indicating a result of the computation.

In this case, as necessary, it is also possible for the route computation section 30 to acquire the result of identifying the free space obtained in Step S13, the result of identifying the parking available position obtained in Step S14, the result of computing the clearance, or the like from the space detection section 24, and utilize it to compute the parking route. At this time, for example, the parking route from the current position of the own vehicle to the parking position of the own vehicle is calculated while using the parking available position as a parking position where parking of the own vehicle is planned.

Note that the CG data to be used for computing the parking route is data that reflects results of identifying the folded/unfolded status of the door mirrors of the own vehicle and the adjacent vehicle. Therefore, the parking route indicated by the route information is also a route to which the results of identifying the folded/unfolded status of the door mirrors of the own vehicle and the adjacent vehicle are added. In other words, the route information depending on the results of identifying the folded/unfolded status of the door mirrors is generated.

In addition, the route computation section 30 may acquire the sensing data recorded on the memory section 23, new sensing data that is successively acquired by the surround camera 21 or the ranging sensor 24, or the like through the space detection section 24, and may use it to compute the parking route.

The CG data is not used for computing the parking route for the above-described normal automatic parking, but the CG data is used for computing the parking route for the highly accurate automatic parking in Step S73. To generate the CG data, the results of identifying the free space and the parking available position obtained from the sensing data, the result of computing the clearance, the position/attitude information, and the three-dimensional shape data of the own vehicle and the adjacent vehicle are used.

Therefore, it can also be said that the computation of the parking route for the highly accurate automatic parking is simulation of parking of the own vehicle in the parking position, the simulation being performed on the basis of the sensing data and the three-dimensional shape data of the own vehicle and the adjacent vehicle. In other words, it is possible for the route computation section 30 to compute the parking route on the basis of the sensing data and the three-dimensional shape data.

By using the three-dimensional shape data (CG data) for computing the parking route in Step S73, it becomes possible to accurately recognize a distance to the adjacent vehicle even with regard to a part located outside the angle of view at the time of acquiring the sensing data. Therefore, this makes it possible to find the clearance or the like more accurately.

Accordingly, it is possible to accurately find the route for parking the own vehicle in the parking position without colliding with an obstacle such as the adjacent vehicle even in a case of parking in a place with poor visibility or a place where a distance between the adjacent vehicles is narrow. This makes it possible to reduce driver's anxiety about parking.

In Step S74, the image generation section 31 generate image data of a virtual space image on the basis of the route information supplied from the route computation section 30, the CG data supplied from the object mapping section 29, and the three-dimensional shape data supplied from the shape data acquisition section 28. In addition, the three-dimensional shape data of the own vehicle may also be appropriately used for generating the image data of the virtual space image.

Note that the CG data to be used for generating the virtual space image (image data) is data that reflects the results of identifying the folded/unfolded status of the door mirrors of the own vehicle and the adjacent vehicle. Therefore, the virtual space image is also an image to which the results of identifying the folded/unfolded status of the door mirrors of the own vehicle and the adjacent vehicle are added. In other words, the virtual space image depending on the results of identifying the folded/unfolded status of the door mirrors is generated.

The virtual space image is an image that indicates a result of simulation of parking of the own vehicle and that is obtained by disposing the own vehicle object and the adjacent vehicle object in the virtual space. The virtual space image may be a still image or a moving image (video) such as an animation image.

For example, as the virtual space image, the image generation section 31 generates an animation image of a scene where the own vehicle (own vehicle object) is being parked in the parking position in the virtual space, an animation image of a track of parking (parking track), i.e., an animation image representing the parking route. At this time, in the virtual space image, the parking track (parking route) may be highlighted, or a place where the own vehicle seems to most likely collide with an obstacle such as the adjacent vehicle (adjacent vehicle object) on the parking track may be highlighted, for example.

In addition, in the virtual space image, it is also possible to display a distance obtained when the own vehicle makes a closest approach to the obstacle such as the adjacent vehicle (interval between the own vehicle and the obstacle) and an enlarged image or the like of an access point (closest point) where the own vehicle makes a closest approach to the obstacle may be displayed.

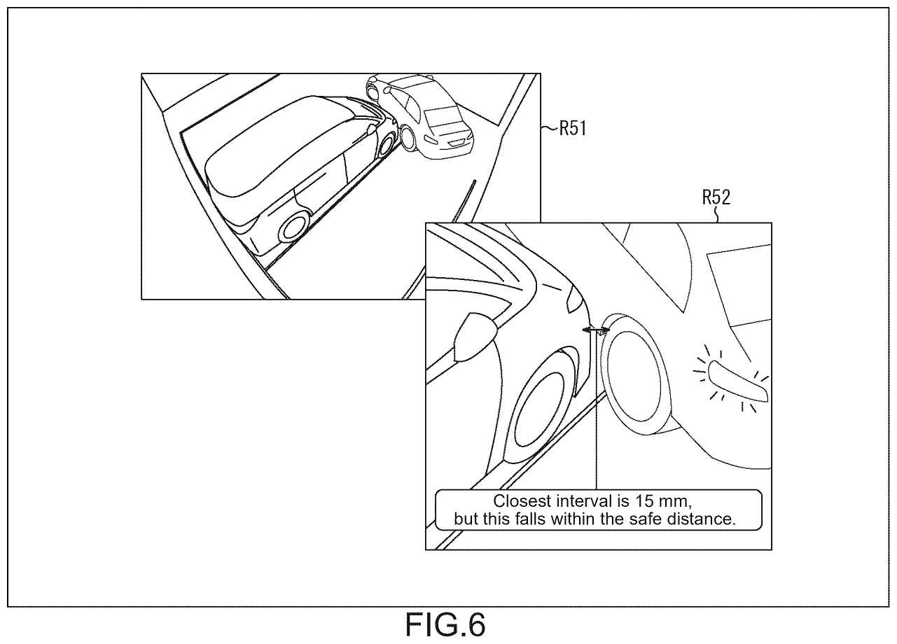

FIG. 6 illustrates the virtual space image, that is, a specific example of a user interface (UI) to be presented to the driver.

With reference to the example illustrated in FIG. 6, a display region R51 and a display region R52 are displayed side by side on the virtual space image.

The display region R51 displays ab animation illustrating a scene where the own vehicle is being parked (highly accurate automatic parking) in the parking position on the basis of the route information obtained in Step S73. In other words, the display region R51 displays the animation image (higher perspective CG video) illustrating parking of the own vehicle from a higher perspective.

On the other hand, the display region R52 displays the closest point where the own vehicle makes a closest approach to the obstacle including the adjacent vehicle when the own vehicle is being parked (highly accurate automatic parking), i.e., an enlarged image of the specific closest point.

The enlarged image also displays an arrow indicating the closest point, and a distance, i.e., a value of the clearance between the own vehicle and the adjacent vehicle (obstacle) at the closest point. In particular, this example displays a text message “Closest interval is 15 mm, but this falls within the safe distance”. This text message includes the value of the clearance and indicates that it is possible to safely achieve the highly accurate automatic parking.

Note that, in order to improve visualization of the closest point, it is also possible to display an enlarged video of the closest point while switching enlarged videos captured at different angles. Here, the example in which the display region R51 and the display region R52 are displayed side by side has been described above. However, it is also possible to switch the displays in such a manner that only any one of the display region R51 and the display region R52 is displayed.

Referring back to the flowchart illustrated in FIG. 3, the image generation section 31 supplies the image data of the generated virtual space image to the vehicle display section 32, and instructs to display the virtual space image.

In Step S75, the vehicle display section 32 presents the virtual space image to the driver by displaying the virtual space image on the basis of the image data supplied from the image generation section 31, and seeks the driver's judgment about whether to start the highly accurate automatic parking.

The driver checks the virtual space image, judges whether to start the highly accurate automatic parking, that is, whether to confirm execution of the highly accurate automatic parking (highly accurate automatic parking control), and operates the input section (not illustrated) in response to a result of the judgment. Then, the input section supplies the route computation section 30 with a signal corresponding to the operation performed by the driver, that is, a signal indicating whether to start the highly accurate automatic parking.

In Step S76, the route computation section 30 determines whether to perform the highly accurate automatic parking control on the basis of the signal from the input section.

In the case where it is determined that the highly accurate automatic parking control will not be performed in Step S76, the information processing system 11 stops the automatic parking assistance, and the process proceeds to Step S67 subsequently. As described above, the manual parking is performed in Step S67.

On the other hand, in the case where it is determined that the highly accurate automatic parking control will be performed in Step S76, the route computation section 30 supplies the route information obtained in Step S73 to the vehicle control section 33 to instruct to start the highly accurate automatic parking control, and the process proceeds to Step S77 subsequently.

In Step S77, the vehicle control section 33 starts the highly accurate automatic parking control on the basis of the route information supplied from the route computation section 30.

In this case, as the highly accurate automatic parking control, the vehicle control section 33 controls the behavior of the own vehicle, that is, the driving or steering of the own vehicle in such a manner that the parking of the own vehicle in the parking position is achieved through the parking route indicated by the route information.

In addition, when performing the highly accurate automatic parking of the own vehicle, for example, the route computation section 30 may successively update the route information by using new sensing data, position/attitude information, or the like obtained during the parking (during performing the highly accurate automatic parking), and may supply the updated route information to the vehicle control section 33. In this case, the vehicle control section 33 appropriately controls behavior (parking) of the own vehicle on the basis of the updated route information.

In addition, for example, when performing the highly accurate automatic parking of the own vehicle, it is also possible for the route computation section 30 to compute a risk of collision of the own vehicle with the adjacent vehicle (obstacle) on the basis of the sensing data, the position/attitude information, the CG data, or the like. Specifically, for example, an actual clearance or a predicted clearance may be used as the risk.

For example, in a case where the clearance becomes equal to or less than the predetermined threshold, it is possible for the route computation section 30 to control the vehicle control section 33 to temporarily stop the highly accurate automatic parking.

In this case, for example, the image generation section 31 may cause the vehicle display section 32 to display a screen or the like that encourages the driver to judge whether to continue the highly accurate automatic parking, and then the vehicle control section 33 may perform a subsequent operation depending on the driver's judgment about whether to continue the highly accurate automatic parking. In other words, the vehicle control section 33 continues or stops the highly accurate automatic parking control in response to an input operation corresponding to the driver's judgment.

The highly accurate automatic parking assistance process ends when the highly accurate automatic parking is achieved.

As described above, the information processing system 11 identifies the vehicle type of the adjacent vehicle on the basis of the sensing data, generates the route information and the virtual space image by using the three-dimensional shape data of the vehicle type, and performs the highly accurate automatic parking control using the three-dimensional shape data.

This makes it possible to reduce driver's anxiety about parking of the own vehicle even in a narrow place or a place with poor visibility.

For example, by using not only the sensing data but also the three-dimensional shape data of the adjacent vehicle, it becomes also possible to accurately recognize a distance to the adjacent vehicle even with regard to a part located outside the angle of view at the time of acquiring the sensing data, and this makes it possible to obtain the clearance or the like more accurately. In other words, this makes it possible to complement the part of the adjacent vehicle or the like located outside the angle of view with the three-dimensional shape data.

This makes it possible to park the own vehicle without colliding with an obstacle such as the adjacent vehicle even in a case where the clearance is small (narrow). In addition, it becomes also possible to easily continue the automatic parking assistance in a narrow parking lot or the like. This makes it possible to reduce anxiety for drivers.

In addition, by presenting the virtual space image generated using the three-dimensional shape data of the adjacent vehicle to the driver, it is possible for the driver to specifically recognize the parking track, the value of clearance, the closest point, and the like. This makes it possible to reduce anxiety about parking.

### Configuration Example of Computer

Incidentally, the series of processes described above can be executed by hardware or can be executed by software. In a case where the series of processes is executed by software, a program configuring the software is installed on a computer. Here, the computer includes, for example, a computer incorporated in dedicated hardware, a general-purpose computer capable of executing various functions by installing various programs, and the like.

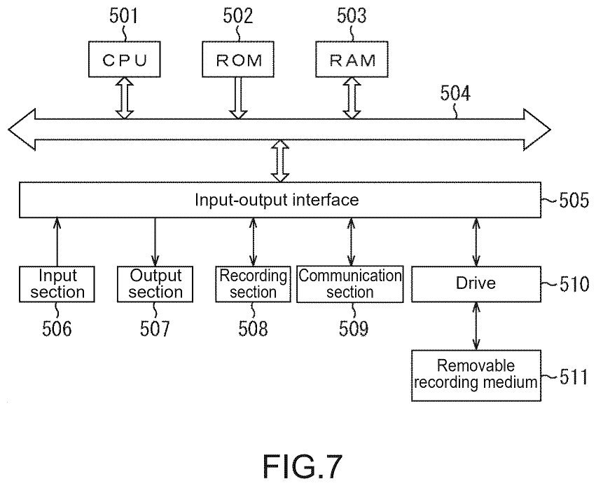

FIG. 7 is a block diagram illustrating a configuration example of hardware of a computer that executes the series of processes described above by means of a program.

In a computer 900, a central processing unit (CPU) 501, a read only memory (ROM) 502, and a random access memory (RAM) 503 are coupled to each other via a bus 504.

The bus 504 is also coupled to an input-output interface 505. The input-output interface 505 is also coupled to an input section 506, an output section 507, a recording section 508, a communication section 509, and a drive 510.

The input section 506 includes, for example, a keyboard, a mouse, a microphone, an imaging element, and the like. The output section 507 includes, for example, a display, a speaker, and the like. The recording section 508 includes, for example, a hard disk, a non-volatile memory, and the like. The communication section 509 includes, for example, a network interface and the like. The drive 510 drives a removable recording medium 511, such as a magnetic disk, an optical disc, a magneto-optical disc, or a semiconductor memory.

In the computer configured as described above, for example, the CPU 501 loads a program recorded on the recording section 508 into the RAM 503 via the input-output interface 505 and the bus 504, and executes the program, thereby performing the series of processes described above.

The program executed by the computer (CPU 501) can be provided by being recorded on the removable recording medium 511 as a package medium, for example. In addition, the program can also be provided via a wired or wireless transmission medium, such as a local area network, the Internet, or digital satellite broadcasting.

In the computer, the program can be installed into the recording section 508 via the input/output interface 505 by mounting the removable recording medium 511 into the drive 510. In addition, the program can be received by the communication section 509 via the wired or wireless transmission medium and installed into the recording section 508. In addition, the program can be installed in advance into the ROM 502 or the recording section 508.

It is to be noted that the program executed by the computer may be a program in which processes are performed in chronological order in accordance with the order described in the present description, or may be a program in which processes are performed in parallel or at a necessary timing such as when a call is made.

Further, embodiments of the present technology are not limited to the above described embodiment, and various modifications may be made to them without departing from the scope of the present technology.

For example, the present technology is also applicable to a cloud computing configuration in which one function is shared and cooperatively processed by a plurality of devices via a network.

In addition, each step described in the above flowcharts can be executed by one device or by a plurality of devices.

Furthermore, in a case where a plurality of processes is included in one step, the plurality of processes included in the one step can be executed by one device or shared and executed by a plurality of devices.

The present technology may also be configured as below.

(1) An information processing device including
an image generation section that generates a virtual space image on the basis of three-dimensional shape data of an adjacent vehicle that is adjacent to a parking position where parking of an own vehicle is planned, the virtual space image indicating a result of simulation of the parking of the own vehicle in the parking position, the simulation being performed on the basis of the three-dimensional shape data and sensing data obtained through sensing of surroundings of the own vehicle.
   (2) The information processing device according to (1), in which
the virtual space image displays an animation of parking of the own vehicle.
   (3) The information processing device according to (1) or (2), in which
the virtual space image displays an enlarged image of a closest point where the own vehicle makes a closest approach to an obstacle including the adjacent vehicle.
   (4) The information processing device according to (3), in which
the virtual space image displays a value of clearance between the own vehicle and the obstacle at the closest point.
   (5) The information processing device according to any one of (1) to (4), further including
a shape data acquisition section that acquires the three-dimensional shape data of a vehicle type of the adjacent vehicle that is identified on the basis of the sensing data.
   (6) The information processing device according to (5), in which
the shape data acquisition section reads out the piece of three-dimensional shape data of the vehicle type of the adjacent vehicle from a database including the prerecorded pieces of three-dimensional shape data for respective vehicle types.
   (7) The information processing device according to (6), in which
in a case where the database does not include the three-dimensional shape data of the vehicle type of the adjacent vehicle, the shape data acquisition section transmits vehicle type information indicating the vehicle type of the adjacent vehicle to a first server and receives the three-dimensional shape data of the vehicle type of the adjacent vehicle from the first server.
   (8) The information processing device according to any one of (5) to (7), in which
the sensing data is image data of an omnidirectional image obtained by capturing an image of the surroundings of the own vehicle as a subject, and
the information processing device further includes:
   a feature amount extraction section that extracts a feature amount of the adjacent vehicle from the omnidirectional image on the basis of the image data; and
   a vehicle type identification section that identifies the vehicle type of the adjacent vehicle on the basis of the feature amount.
      (9) The information processing device according to (8), in which
the vehicle type identification section identifies the vehicle type of the adjacent vehicle by checking the feature amount against the prestored feature amounts for respective vehicle types.
   (10) The information processing device according to (8), in which
the vehicle type identification section identifies the vehicle type of the adjacent vehicle by transmitting the feature amount to a second server and receiving, from the second server, vehicle type information showing a vehicle type corresponding to the feature amount.
   (11) The information processing device according to any one of (5) to (10), in which
the image generation section causes a vehicle type notification screen to be displayed, the vehicle type notification screen indicating a result of identification of the vehicle type of the adjacent vehicle.
   (12) The information processing device according to (11), in which
the vehicle type notification screen displays reliability of the result of identification of the vehicle type of the adjacent vehicle.
   (13) The information processing device according to any one of (5) to (12), in which
the shape data acquisition section acquires the three-dimensional shape data corresponding to a folded/unfolded status of a door mirror of the adjacent vehicle that is identified on the basis of the sensing data.
   (14) The information processing device according to any one of (1) to (13), further including
a route computation section that computes a parking route to the parking position of the own vehicle on the basis of the sensing data and the three-dimensional shape data, in which
the image generation section generates the virtual space image on the basis of route information indicating the parking route.
   (15) The information processing device according to (14), further including
a vehicle control section that controls parking of the own vehicle on the basis of the route information.
   (16) The information processing device according to any one of (1) to (15), in which
the sensing data includes at least one of image data of an omnidirectional image obtained by capturing an image of the surroundings of the own vehicle as a subject, or ranging data obtained through measurement of a distance to an object around the own vehicle.
   (17) An information processing method including
generating, by an information processing device, a virtual space image on the basis of three-dimensional shape data of an adjacent vehicle that is adjacent to a parking position where parking of an own vehicle is planned, the virtual space image indicating a result of simulation of the parking of the own vehicle in the parking position, the simulation being performed on the basis of the three-dimensional shape data and sensing data obtained through sensing of surroundings of the own vehicle.
   (18) An information processing system including:
an information processing device including an image generation section that generates a virtual space image on the basis of three-dimensional shape data of an adjacent vehicle that is adjacent to a parking position where parking of an own vehicle is planned, the virtual space image indicating a result of simulation of the parking of the own vehicle in the parking position, the simulation being performed on the basis of the three-dimensional shape data and sensing data obtained through sensing of surroundings of the own vehicle; and
a display device that displays the virtual space image.

### REFERENCE SIGNS LIST

11 information processing system
21 surround camera
22 ranging sensor
23 memory section
24 space detection section
25 vehicle feature amount extraction section
26 estimation section
27 vehicle type identification section
28 shape data acquisition section
29 object mapping section
30 route computation section
31 image generation section
32 vehicle display section
33 vehicle control section

1. An information processing device comprising
an image generation section that generates a virtual space image on a basis of three-dimensional shape data of an adjacent vehicle that is adjacent to a parking position where parking of an own vehicle is planned, the virtual space image indicating a result of simulation of the parking of the own vehicle in the parking position, the simulation being performed on a basis of the three-dimensional shape data and sensing data obtained through sensing of surroundings of the own vehicle.

2. The information processing device according to claim 1, wherein
the virtual space image displays an animation of parking of the own vehicle.

3. The information processing device according to claim 1, wherein
the virtual space image displays an enlarged image of a closest point where the own vehicle makes a closest approach to an obstacle including the adjacent vehicle.

4. The information processing device according to claim 3, wherein
the virtual space image displays a value of clearance between the own vehicle and the obstacle at the closest point.

5. The information processing device according to claim 1, further comprising
a shape data acquisition section that acquires the three-dimensional shape data of a vehicle type of the adjacent vehicle that is identified on a basis of the sensing data.

6. The information processing device according to claim 5, wherein
the shape data acquisition section reads out the piece of three-dimensional shape data of the vehicle type of the adjacent vehicle from a database including the prerecorded pieces of three-dimensional shape data for respective vehicle types.

7. The information processing device according to claim 6, wherein
in a case where the database does not include the three-dimensional shape data of the vehicle type of the adjacent vehicle, the shape data acquisition section transmits vehicle type information indicating the vehicle type of the adjacent vehicle to a first server and receives the three-dimensional shape data of the vehicle type of the adjacent vehicle from the first server.

8. The information processing device according to claim 5, wherein
the sensing data is image data of an omnidirectional image obtained by capturing an image of the surroundings of the own vehicle as a subject, and
the information processing device further comprises:
a feature amount extraction section that extracts a feature amount of the adjacent vehicle from the omnidirectional image on a basis of the image data; and
a vehicle type identification section that identifies the vehicle type of the adjacent vehicle on a basis of the feature amount.

9. The information processing device according to claim 8, wherein
the vehicle type identification section identifies the vehicle type of the adjacent vehicle by checking the feature amount against the prestored feature amounts for respective vehicle types.

10. The information processing device according to claim 8, wherein
the vehicle type identification section identifies the vehicle type of the adjacent vehicle by transmitting the feature amount to a second server and receiving, from the second server, vehicle type information showing a vehicle type corresponding to the feature amount.

11. The information processing device according to claim 5, wherein
the image generation section causes a vehicle type notification screen to be displayed, the vehicle type notification screen indicating a result of identification of the vehicle type of the adjacent vehicle.

12. The information processing device according to claim 11, wherein
the vehicle type notification screen displays reliability of the result of identification of the vehicle type of the adjacent vehicle.

13. The information processing device according to claim 5, wherein
the shape data acquisition section acquires the three-dimensional shape data corresponding to a folded/unfolded status of a door mirror of the adjacent vehicle that is identified on a basis of the sensing data.

14. The information processing device according to claim 1, further comprising
a route computation section that computes a parking route to the parking position of the own vehicle on the basis of the sensing data and the three-dimensional shape data, wherein
the image generation section generates the virtual space image on a basis of route information indicating the parking route.

15. The information processing device according to claim 14, further comprising
a vehicle control section that controls parking of the own vehicle on a basis of the route information.

16. The information processing device according to claim 1, wherein
the sensing data includes at least one of image data of an omnidirectional image obtained by capturing an image of the surroundings of the own vehicle as a subject, or ranging data obtained through measurement of a distance to an object around the own vehicle.

17. An information processing method comprising
generating, by an information processing device, a virtual space image on a basis of three-dimensional shape data of an adjacent vehicle that is adjacent to a parking position where parking of an own vehicle is planned, the virtual space image indicating a result of simulation of the parking of the own vehicle in the parking position, the simulation being performed on a basis of the three-dimensional shape data and sensing data obtained through sensing of surroundings of the own vehicle.

18. An information processing system comprising:
an information processing device including an image generation section that generates a virtual space image on a basis of three-dimensional shape data of an adjacent vehicle that is adjacent to a parking position where parking of an own vehicle is planned, the virtual space image indicating a result of simulation of the parking of the own vehicle in the parking position, the simulation being performed on a basis of the three-dimensional shape data and sensing data obtained through sensing of surroundings of the own vehicle; and
a display device that displays the virtual space image.
